(19) United States
(12) Patent Application Publication
(10) Pub. No.: US 2016/0107096 A1
(43) Pub. Date: Apr. 21, 2016

(54) HORSE JUMPING SYSTEM

(71) Applicant: Daryl Flynn, Hollis, NH (US)

(72) Inventor: Daryl Flynn, Hollis, NH (US)

(21) Appl. No.: 14/519,951

(22) Filed: Oct. 21, 2014

(51) Int. Cl. A63K 3/04; A01K 15/02

(52) U.S. Cl. CPC A63K 3/046; A01K 15/027

(57) ABSTRACT

A method and apparatus for using a transportable horse jumping system are disclosed. The horse jumping system includes a portable standard having a panel for supporting one or more poles, the panel having at least one of a pole holder and a keyway, and a support leg attached to the panel and adapted to maintain the panel in a vertical position. The one or more poles extend generally perpendicularly from a front of the panel. In some embodiments, one or more jump cups are attached to the keyway for supporting the one or more poles. In such embodiments, jump poles may be inserted into at least one of the pole holders and the jump cups.

### FIELD

The disclosed embodiments are generally directed to horse jumping systems, and more particularly to portable horse jumping systems.

### BACKGROUND

Horse jumping systems, which include assemblies known as standards for supporting jump poles, are used for equestrian training and competitions. Some versions include large, fixed standards (e.g., wooden standards that are about six feet tall) that are heavy and are not easy for individual equestrians to transport and assemble.

### SUMMARY OF INVENTION

According to one embodiment, a portable standard of a horse jumping system is disclosed. The standard includes a panel for supporting one or more poles, the panel having at least one of a pole holder and a keyway, and a support leg attached to the panel and adapted to maintain the panel in a vertical position. The one or more poles extend generally perpendicularly from a front of the panel.

According to another embodiment, a method of using a horse jumping system having first and second portable standards is disclosed. The first standard has a first panel and a first support leg and the second standard has a second panel and a second support leg. The method includes attaching the first support leg to the first panel, the first panel having at least one of a first pole holder and a first keyway, attaching the second support leg to the second panel, the second panel having at least one of a second pole holder and a second keyway, placing the first and second standards on a surface, a front of the first panel facing a front of the second panel, and attaching a first pole to the first and second panels, the first pole extending generally perpendicularly from the front of the first panel and the front of the second panel.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a standard according to one embodiment;

FIG. 2 is a perspective view of a panel of a standard according to one embodiment;

FIG. 3 is a perspective view of a standard according to another embodiment; and

FIG. 4 is a perspective view of a horse jumping system with two of the standards shown in FIG. 3 configured for a horse jump.

### DETAILED DESCRIPTION OF INVENTION

Horse jumping systems, which include assemblies known as standards for supporting jump poles, are used to train for and compete in horse jumping events. Typically, standards are about six feet tall and relatively heavy, and thus, are not easily transported and assembled by an individual equestrian. As such, the equestrian may either practice in a facility that has assembled standards or may seek assistance to transport and assemble the standards in another practice location (e.g., in an open field). In such embodiments, the standards may be used with accessories like jump poles and/or jump cups.

According to one aspect, a transportable or travel standard is disclosed. In some embodiments, the standard is lightweight such that the individual equestrian may assemble and disassemble the standard without assistance. In one embodiment, the standard is configured to be collapsible (e.g., stackable), such that the equestrian may transport the standard in a horse trailer, for example, with the accessories (e.g., jump poles and/or jump cups).

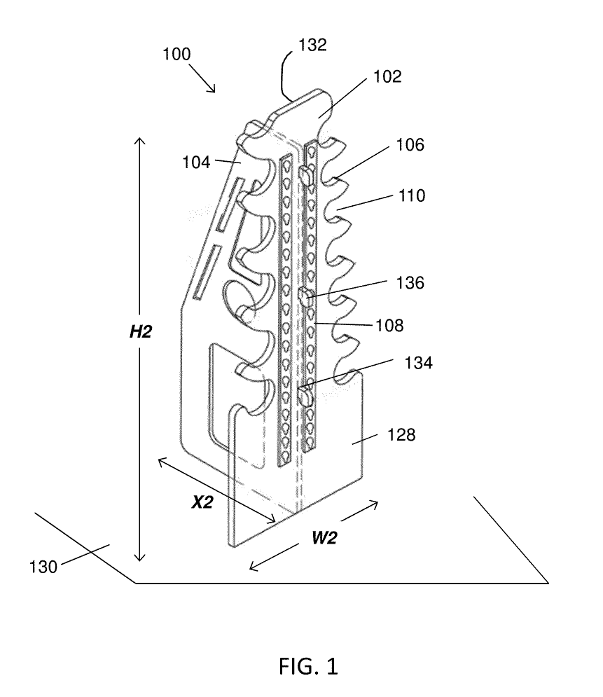

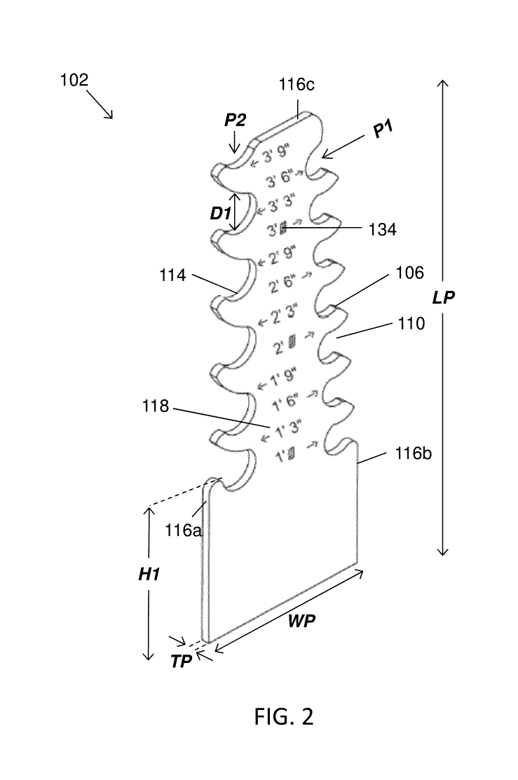

As illustrated in FIG. 1, in one embodiment, a standard 100 includes a panel 102 and a support leg 104. As will be described, the panel 102 is configured to support one or more poles for horse jumping. For example, the panel 102 may include one or more pole holders 106 and/or one or more keyways 108. For purposes herein, a panel may include a structure having a length and width that is much greater than its thickness. For example, as shown in FIG. 2, the panel may have a length LP of about 4 feet, a width WP of about 16 inches, and a thickness TP of about 1 inch. In such an embodiment, the ratio between the length, width, and thickness of the panel (LP:WP:TP) is about 3.00:1.00:0.06. As will be appreciated, a support leg may include any structure suitable for maintaining the panel in a generally vertical position. In some embodiments, the support leg 104 also includes a panel, as shown in FIG. 1, although the support leg 104 may have other suitable configurations.

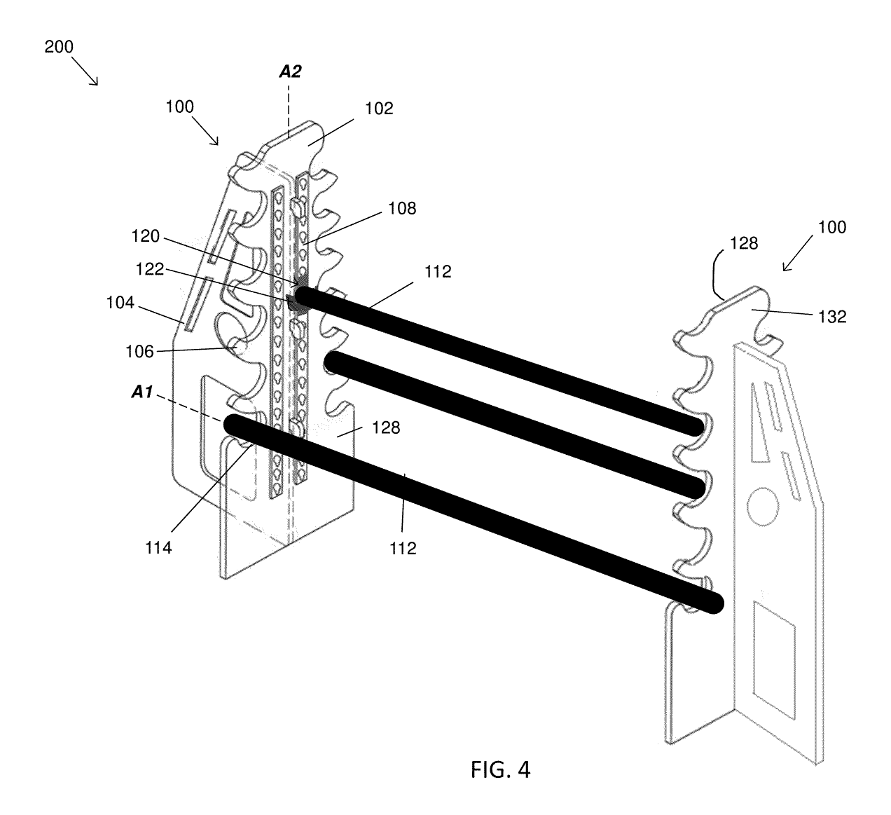

In some embodiments, as shown in FIGS. 1 and 2, the panel 102 includes one or more pole holders 106 having an opening 110 adapted to receive a jump pole 112. For example, as illustrated in FIG. 4, when the pole 112 is inserted into the opening 110 of the pole holder 106, a bottom surface 114 of the pole holder 106 cradles the pole 112. In some embodiments, the pole 112 is inserted into the pole holder 106 via a side of the opening 110, as shown by the arrow labeled P1 (see FIG. 2). As shown in FIG. 4, when the poles 112 are cradled by the pole holders 106, each pole extends generally perpendicularly to a front 128 of the panel 102. That is, a longitudinal axis of the pole 112 (see A1) is generally perpendicular the front 128 of the panel (e.g., perpendicular to a longitudinal axis of the panel 102, labeled A2).

In some embodiments, the pole holders 106 are sized such that the jump poles 112 may be removably coupled to the pole holders 106. In one embodiment, the opening 110 of the pole holder 106 has a diameter D1 that is larger than a diameter of the jump pole 112. As will be appreciated, the opening 110 may be sized to accommodate a standard-sized jump pole (e.g., a jump pole that is commercially available). The opening 110 also may be sized to accommodate other jump poles (e.g., unique jump poles that are designed to be used with the system). In one embodiment, the opening 110 is sized to accommodate a jump pole having a diameter of about 3 inches.

In some embodiments, the shape of the pole holder 106 (e.g., the shape of the opening 110 and the shape of the bottom surface 114) correspond to the shape of the pole 112. For example, as shown in FIG. 2, the pole holder 106 may have a substantially circular-shaped opening 110 and a curved bottom surface 114. As will be appreciated, the pole holder 106 also may have other shapes suitable for holding the pole 112. For example, the pole holder 106 may have a square, oval, triangular, other polygonal or other shaped opening 110.

As shown in FIG. 2, the pole holders 106 may be formed in each side 116a, 116b of the panel 102 and/or in a top 116c of the panel 102. In embodiments in which the pole holder 106 is formed in the top 116c of the panel 102, the pole holder 106 includes only a bottom surface 114 (e.g., a curved bottom surface 114) that is adapted to cradle the pole 112 when the pole is inserted from above, as shown by the arrow labeled P2.

As will be appreciated, pole holders 106 may be formed in only one of the sides 116a, 116b of the panel 102 and/or in only the top 116c of the panel 102. As shown in FIG. 1, in which the left side 116a of the panel 102 has five pole holders 106 and the right side 116b of the panel 102 has seven pole holders 106, the number of pole holders 106 may vary from side to side. In other embodiments, the number of pole holders 106 in each side 116a, 116b of the panel may be the same. The pole holders 106 also may have the same shape and size, as illustrated FIGS. 1 and 2, while in other embodiments, the shape and size of the pole holders 106 may vary from pole holder to pole holder.

As shown in FIG. 2, in some embodiments, the pole holder 106 has a height H1, which corresponds to a vertical distance between the pole 112 and the ground when the pole 112 is held by the pole holder 106. In some embodiments, the height H1 of each pole holder 106 corresponds to a standard jump height (e.g., a jump height that is used during horse jumping competitions). The pole holders 106 also may have other heights H1 suitable for practice or competing. In some embodiments, to facilitate an easy setup of the system, the panel 102 includes labels 118 that identify the height H1 of each pole holder 106 (e.g., 1′ and 1′ 3″). In such embodiments, the equestrian need not adjust the standard 100 or guess the correct position for inserting the pole 112. Instead, the equestrian may simply locate the label with the height H1 of the jump she would like to practice and insert the pole 112 into the corresponding pole holder 106.

Although the panel 102 illustrated in FIG. 2 has thirteen pole holders 106 (five on the left side 116a, seven on the right side 116b, and one on the top 116c of the panel 102), the panel 102 may have more or fewer pole holders 106. In such embodiments, the panel 102 may have more or fewer labels 118 corresponding to the height H1 of each pole holder 106. The pole holders also may be located at different heights than those identified by the labels 118 in FIG. 2.

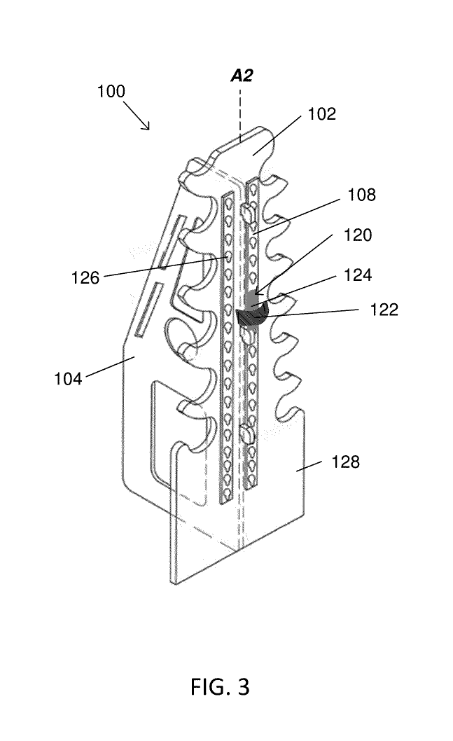

In some embodiments, as shown in FIG. 3, the panel 102 includes one or more keyways 108 that are adapted to receive one or more jump cups 120. As illustrated in FIG. 4, the jump cup 120 has a cradle portion 122 that supports the jump pole 112 for a horse jump. In some embodiments, the jump cup 120 is a pinless jump cup. As with the pole holders 106, the cradle portion 122 may be shaped and sized to hold the jump pole 112. In one embodiment, as is illustrated, the cradle portion 122 has a curved bottom surface that corresponds to the cylindrical shape of the jump pole 112.

As shown in FIG. 3, the cradle portion 122 of the jump cup 120 extends outwardly from a front 124 of the jump cup 120. In some embodiments, the cradle portion 122 extends substantially perpendicular to the front 124 of the jump cup 120. As will be appreciated, similar to the pole holders, when the jump pole 112 is held by the jump cup 120, the pole 112 may extend generally perpendicularly from the front 128 of the panel 102.

In some embodiments, the jump cup 120 has a rear (not shown), opposite the front 124, which includes one or more attachment pins (not shown). As will be appreciated, the one or more pins (not shown) of the jump cup 120 are configured to removably engage with the openings 126 on the track of the keyway 108. For example, in one embodiment, the pins (not shown) are inserted into the openings 126 on the keyway 108 and the jump cup 120 is lowered to couple the jump cup 120 to the keyway 108. In some embodiments, the keyways 108 are configured to engage with standard jump cups 120 (e.g., jump cups that are commercially available). In such embodiments, the openings 120 on the keyway 108 are configured to correspond to the attachment pins on the standard jump cups 120. In other embodiments, the keyways 108 are configured to engage with unique jump cups 120 (e.g., unique jump cups that are designed to engage only with the keyways 108 on the panel 102). As will be appreciated, in such embodiments, the openings 126 on the keyways will be configured to engage with the pins (not shown) on the unique jump cups 120.

As shown in FIG. 3, the keyways 108 extend along a front 128 of the panel 102. In some embodiments, as is shown, the keyways 108 extend along a portion of a length of the front 128 of the panel. The keyways 108 also may extend along an entire length of the front 128 of the panel. In some embodiments, the keyways 108 extend along a longitudinal axis of the front side 128 of the panel (see, e.g., A2).

As will be appreciated, although two keyways 108 are shown on the panel 102, in other embodiments, the panel 102 may include more or fewer keyways 108. For example, in one embodiment the panel 102 may include one keyway and in another embodiment the panel 102 may include three or more keyways 108. As will also be appreciated, the keyways 108 may be the same size in some embodiments (e.g., extending along the same length of the front side 128 of the panel), although the size of the keyways 108 also may vary from keyway to keyway. In some embodiments, the panel 108 may include a first keyway configured to engage with standard jump cups 120 and a second keyway configured to engage with unique jump cups.

In some embodiments, the keyways 108 are removably attachable to the front side 128 of the panel 102 (e.g., via hooks or fasteners). In other embodiments, the keyways 108 may be substantially permanently attached to the front side 128 of the panel 102 (e.g., by an adhesive or other substantially permanent attachment method). As will be appreciated, the keyways 108 and the panel 102 also may be integrally formed as a single extrusion.

Although the panel 102 is shown as having pole holders 106 and keyways 108 in FIGS. 1 and 3, a person having ordinary skill in the art should appreciate that the panel 102 may include only pole holders 106, as shown in FIG. 2, or may include only keyways 108. The panel 102 also may include different combinations of the keyways 108 and pole holders 106 than those shown in the figures. For example, in one embodiment, the panel 102 may include one keyway 108 and more than one pole holders 106. As will be appreciated, in embodiments having both pole holders 106 and keyways 108, the pole holders 106 may be used to quickly setup the standard for a horse jump as the equestrian need only insert the pole(s) into the pole holder(s) 106.

As previously described, in some embodiments, the standard 100 includes a support leg 104 configured to maintain the panel 102 in a generally vertical position (e.g., an in-use position). As shown in FIG. 1, when the standard 100 is in an in-use position, both the panel 102 and support leg 104 rest stably on a surface 130 (e.g., the ground).

In some embodiments, the support leg 104 extends outwardly from a rear 132 of the panel 102 (e.g., the side opposite the front 128 of the panel 102). In one embodiment, the support leg 104 extends substantially perpendicular from the rear 132 of the panel 102. As illustrated in FIG. 1, in such an embodiment, the standard 100 has a “T” shape (e.g., when viewed from a top of the standard) when the support leg 104 is attached to the panel 102.

As will be appreciated, in some embodiments, the support leg 104 may include two or more legs that extend outwardly from the rear 132 of the panel. In embodiments having two legs, for example, the standard 100 may have a “V” shape (e.g., when viewed from the top of the standard) when the support leg 104 is attached to the panel 102.

As illustrated in FIG. 1, in some embodiments, the support leg 104 does not reach the top 116c of the panel 102. In such embodiments, when the panel 102 and support leg 104 are placed on the surface, a vertical height of the support leg 104 (e.g., a length of the support leg 104) is less than a vertical height of the panel 102 (e.g., a length of the panel 102). As will be appreciated, the support leg 104 and the panel 102 also may be configured to have the same vertical height.

In some embodiments, the assembled standard 100 has a vertical height H2 of about 4 feet, although the standard may have other suitable heights. For example, in other embodiments, the height H2 of the standard is between about 3 feet and about 5 feet. The assembled standard 100 also has a width W2, which in some embodiments is about 16 inches, although other suitable widths may be used. The depth X2 of the assembled standard 100 may be about 16 inches, although other suitable depths may be used.

In some embodiments, the support leg 104 is removably attachable to the panel 102, such that the standard 100 can be easily assembled and disassembled. In one embodiment, as illustrated in FIGS. 1 and 2, the support leg includes latches 136 that engage with corresponding recesses 134 in the panel 102. In such an embodiment, the latches 136 are inserted into the recesses 134 and the support leg 104 is lowered, thus coupling the support leg 104 to the panel 102. As will be appreciated, when the support leg 104 is lowered, an edge of each latch 136 engages with an edge of each recess 134. In some embodiments, the recesses 134 are sized such that the latches 136 may be removably inserted into the corresponding recesses 134 for coupling the panel 102 to the support leg 104.

As will be appreciated, although the support leg 104 and panel 102 are shown as having three latches 136 and three corresponding recesses 134, a person having ordinary skill in the art should appreciate that the support leg 104 and panel 102 may have more or fewer latches 136 and corresponding recesses 134, respectively. In some embodiments, the number of latches 136 and corresponding recesses 134 may differ. For example, the panel 102 may have four recesses 134 while the support leg 104 has only 3 latches 136. As will be appreciated, in such embodiments, the panel 102 has at least as many recesses 134 as the latches 136 on the support leg 104. Although the standard 100 is show with the support leg 104 having latches 136 that engage with the corresponding recesses 134 on the panel 102, a person having ordinary skill in the art should appreciate that the panel 102 may have latches that engage with corresponding recesses on the support leg 104.

Although the support leg 104 is shown as being attached to the panel 102 via the latches 136, it should be appreciated that other assemblies may be used to attach the panel 102 to the support leg 104. For example, in another embodiment, the support leg 104 may be hingedly attached to the panel 102. In such an embodiment, the panel 102 may be connected to the support leg 104 via one or more hinges (not shown). To assemble the standard 100, the equestrian may pivot the support leg 104 away from the panel 102 until the support leg 104 is substantially perpendicular to the panel (e.g., forming the “T” shaped standard). To disassemble the standard 100, the support leg 104 may be pivoted towards the panel 102 until a side of the support leg 104 is positioned against the rear 132 of the panel 102.

As will be appreciated, although the standard 100 is shown as having the support leg 104 removably attachable to the panel 102, the support leg 104 also may be permanently attached to the panel 102. For example, as described above, the support leg 104 may be hingedly attached to the panel 102. In other embodiments, the support leg 104 and panel 102 may be glued or connected with another substantially permanent attachment method. The support leg 104 and panel 102 also may be integrally formed as a single extrusion.

As previously described, the standard 100 may be configured to have a lightweight construction such that it can be easily transported and assembled. In some embodiments, the standard 100 (e.g., the panel and the support leg) may include a plastic material. As will be appreciated, the selected plastic material is configured to be heavy enough to allow the standard to maintain a stable, vertical position while supporting one or more poles yet light enough so that the equestrian can easily transport and assemble the standard. The standard 100 also may include other lightweight materials, for example a wooden material. In such embodiments, the panel 102 and support leg 104 may be cut from a plastic or wooden panel or may be formed with a more modern fabrication technique (e.g., 3D printing).

As will be appreciated, while the panel 102 and support leg 104 may be formed of the same material, the panel 102 and support leg 104 also may be formed of different materials. For example, in some embodiments both the panel 102 and support leg 104 are formed of a plastic material, while in other embodiments, the panel 102 is formed of a plastic material while the support leg 104 is formed of a different material (e.g., a wooden material).

FIG. 4 illustrates a horse jumping system 200 having first and second standards 100 arranged for a horse jump. As shown in this embodiment, for each standard, the panel 104 is coupled to the support leg 102. The standards 100 may be placed on a stable surface and arranged such that the front 128 of each panel 102 is facing one another. In some embodiments, the standards 100 are spaced apart from one another, with the distance between the first and second standards 100 being large enough to allow a horse to travel therebetween. As will be appreciated, the distance between the first and second standards 100 may be less than a length of the one or more poles 112, as the system 200 is configured to stably hold the poles 112 in the pole holders 106 and/or the jump cups 120.

According to another embodiment, a method of using the horse jumping system is disclosed. In some embodiments, the method includes assembling first and second standards by attaching a first support leg to a first panel and attaching a second support leg to a second panel, respectively. The first and second standards may then be placed on a surface with the first panel distanced from the second panel and with the front of the first and second panels facing one another. As previously described, attaching the support leg to the panel may include inserting one or more latches of the support leg into one or more corresponding recesses in the panel.

The method also may include inserting a first end of the pole into a first pole holder on the first panel and inserting a second end of the pole into a second, corresponding pole holder on the second panel. In such an embodiment, the equestrian may first locate the labels on the first and second panels that correspond to the jump height she wishes to practice and inserts the pole into the corresponding pole holders of the first and second panels. As will be appreciated, the height of the first pole holder may be the same as the height of the second pole holder. In some embodiments, the method further includes attaching one or more jump cups to the keyways on the front side of each panel. The vertical height of the jump cup on the first panel (e.g., in the first keyway) may be the same as the vertical height of the jump cup on the second panel (e.g., in the second keyway). After attachment of the jump cups, a first end of a second pole may be inserted into the first jump cup and a second end of the second pole may be inserted into the second jump cup. The equestrian may repeat these steps to attach additional poles to one or more pole holders and/or to one or more jump cups.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A portable standard of a horse jumping system, the standard comprising:
a panel for supporting one or more poles, the panel having at least one of a pole holder and a keyway; and
a support leg attached to the panel and adapted to maintain the panel in a vertical position;
wherein the one or more poles extend generally perpendicularly from a front of the panel.

2. The standard of claim 1, further comprising a locking arrangement for removably attaching the panel with respect to the support leg.

3. The portable standard of claim 2, wherein the locking arrangement comprises one or more latches on one of the panel and the support leg and one or more corresponding recesses on the other of the panel and the support leg.

4. The standard of claim 1, wherein the panel is hingedly attached to the support leg.

5. The standard claim 1, wherein the panel comprises a first keyway adapted to receive one or more jump cups.

6. The standard of claim 5, wherein the first keyway is disposed on the front of the panel, the support leg extending outwardly from a rear of the panel.

7. The standard of claim 5, further comprising a second keyway adapted to receive one or more jump cups.

8. The standard of claim 5, wherein the first keyway is removably attachable to the panel.

9. The standard of claim 1, wherein the panel comprises one or more pole holders, each of the one or more pole holders being adapted to receive a pole.

10. The standard of claim 9, wherein each of the one or more pole holders has a set jump height.

11. The standard of claim 9, wherein each of the one or more pole holders is adapted to receive a pole having a diameter of about 3 inches.

12. The standard of claim 10, wherein the panel has one or more labels corresponding to the jump height of each of the one or more pole holders.

13. The standard of claim 9, wherein each of the one or more pole holders is formed in a side of the panel.

14. The standard of 9, wherein each of the one or more pole holders comprises an opening having a substantially circular shape.

15. The standard of claim 1, wherein the support leg extends substantially perpendicular to the panel.

16. The standard of claim 1, wherein each of the panel and the support leg includes a plastic material.

17. A method of using a horse jumping system having first and second portable standards, the first standard having a first panel and a first support leg and the second standard having a second panel and a second support leg, the method comprising:
attaching the first support leg to the first panel, the first panel having at least one of a first pole holder and a first keyway;
attaching the second support leg to the second panel, the second panel having at least one of a second pole holder and a second keyway;
placing the first and second standards on a surface, a front of the first panel facing a front of the second panel;
attaching a first pole to the first and second panels, the first pole extending generally perpendicularly from the front of the first panel and the front of the second panel.

18. The method of claim 17, wherein attaching the first pole comprises inserting a first end of the first pole into the first pole holder and inserting a second end of the first pole into the second pole holder.

19. The method of claim 17, further comprising attaching a first jump cup to the first keyway and attaching a second jump cup to the second keyway; wherein attaching the first pole comprises inserting a first end of the first pole into the first jump cup and inserting a second end of the first pole into the second jump cup.

20. The method of claim 17, further comprising attaching a second pole to the first and second panels, the second pole extending generally perpendicularly from the front of the first panel and the front of the second panel.
